(19) United States
(12) Patent Application Publication
(10) Pub. No.: US 2026/0112166 A1
(43) Pub. Date: Apr. 23, 2026

(54) INTELLIGENT FLAGGING AND RECAP GENERATION FOR MEDIA CONTENT

(71) Applicant: DISH Network L.L.C., Englewood, CO (US)

(72) Inventors: Christopher Kuhrt, Englewood, CO (US); Levi Boscardin, Denver, CO (US); Adhish Patel, Jersey City, NJ (US)

(73) Assignee: DISH Network L.L.C., Englewood, CO (US)

(21) Appl. No.: 18/921,466

(22) Filed: Oct. 21, 2024

(51) Int. Cl. G06V 20/40

(52) U.S. Cl. CPC G06V 20/47; G06V 20/42

(57) ABSTRACT

Systems, devices, and processes can generate flags and recaps for content. An example process includes retrieving program data related to a selected program in response to a request for a summary of the program. The program data can be analyzed using an artificial intelligence (AI) model to generate flags for scenes of interest in the selected program. The selected program is played back with the flags overlayed on a timeline of the selected program during playback of the content. The flags identify the scenes of interest as containing content relevant to later content. The scenes of interest identified by the flags can be aggregated to automatically generate a recap of the content relevant to the later content. The recap is presented to a viewer in response to the viewer initiating playback of the later content.

### TECHNICAL FIELD

The following generally relates to automated generation of content summaries and flagging related to television programs, movies, or other media content. Some implementations may make use of artificial intelligence (AI) constructs, as described herein.

### BACKGROUND

Media consumption has undergone a remarkable evolution in recent years, transitioning from a collective family activity centered around the living room television set to a highly personalized experience that can be enjoyed across a multitude of devices and settings. In the bygone era, viewers were bound to programming schedules and limited media distribution, thereby constraining their television and movie watching to specific times and places. Now, with the proliferation of advanced streaming services and portable devices such as smartphones, tablets, and laptops, individuals have the freedom to access a diverse range of media content anytime and anywhere.

The shift to on-demand viewing liberates users from the constraints of traditional broadcasting schedules and geographic limitations, offering unprecedented convenience and choice. The modern landscape of media consumption, bolstered by technologies like digital video recorders and streaming media, caters to the individual's preferences and provides a tailored viewing experience. This has made an extensive library of content more accessible than ever, eliminating the barriers of space and time that once limited viewing opportunities. For example, live content such as sporting events can now be streamed without using traditional satellite or cable television services.

The broad category of viewers can sometimes develop a particular interest in a portion of a program or event. Quotes or segments of a program can trend on social media, causing increased interest in the referenced portions of the program. However, users cannot typically identify the segments of interest in unindexed streams. Similarly, content providers may not have access to summaries of live events or newer programs that can aid viewers in their viewing decisions.

### BRIEF DESCRIPTION

Systems, devices, and automated processes described herein can automatically generate flags and recaps for selected content. An example automated process for generating flags and recaps for content may include the step of retrieving program data related to a selected program in response to a request for a summary of the program. The program data can be analyzed using an artificial intelligence (AI) model to generate flags for scenes of interest in the selected program. The selected program is played back with the flags overlayed on a timeline of the selected program during playback of the content.

In various embodiments, the flags identify the scenes of interest as containing content relevant to later content. The scenes of interest identified by the flags can be aggregated to automatically generate a recap of the content relevant to the later content. The recap is presented to a viewer in response to the viewer initiating playback of the later content. A flag from the flags identifies a playback action taken by other users at a corresponding location on the timeline of the selected program. The playback action is executed in response to a user interaction with the flag.

Additional embodiments may include other systems, devices, computing systems, and automated processes similar to those described herein.

### BRIEF DESCRIPTION OF THE DRAWINGS

FIG. 1 illustrates an example data processing system for automated generation and distribution of content summaries relating to media programs, in accordance with various embodiments.

FIG. 2 illustrates an example display including automatically-generated flags for a media program, in accordance with various embodiments.

FIG. 3 illustrates an example of an automated process to automatically generate summaries relating to media programs, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description. The detailed description refers to the accompanying drawings, which show such embodiments by way of illustration. While these embodiments are described in sufficient detail to enable those skilled in the art to practice the inventions, it should be understood that other embodiments may be realized, and that logical and mechanical changes may be made without departing from the spirit and scope of the inventions. The detailed description herein is thus presented for purposes of illustration only and not of limitation. For example, the steps recited in any of the method or process descriptions may be executed in any order and are not necessarily limited to the order presented.

According to various embodiments, the media viewing experience can be greatly improved by providing automatically-generated content summaries. These automatically-generated summaries can include video recaps for presentation to users seeking to quickly consume content, evaluate potential content, search for points of interest in the content, or are otherwise interested in video recaps of content. Content recaps can include a compilation of scenes flagged as points of interest. The flags can be separately indicated on a playback timeline for the content. For example, a summary can include play times or flags identifying scene changes, flags for scenes with particular relevance to character development or plot, flags for scenes of interest in sporting events or other live broadcasts, flags for commonly rewatched or rewound segments of content, flags for commonly skipped segments of content, flags for commonly searched content, or other flags based on user behavior while consuming content.

In some embodiments, facial recognition or other object recognition techniques may be used to identify the characters or other objects in a given scene. Audio levels can also be used for scene detection or emotional detection. For example, a sports commentator getting excited or increased crowd noise may indicate a major scene/play of interest. Content summaries may also be based on social media, traditional media, web-based media, or other sources that identify clips of content, quote content, summarize content, or otherwise relate to or reference media content. The summary generation engine can access closed caption data, voice to text data, scene recognition data, social media data, web data, user viewing data, closed-loop data, the content itself, or other data related to a particular piece of content to summarize the content.

Summaries can be integrated into content, presented at the beginning of content playback, presented during content browsing, embedded in timelines, or otherwise provided on a display to viewers. In some examples, content summaries can be presented on a “second screen” or other companion device such as a phone, tablet, computer, or other web-browsing device, as the viewer is watching the program, browsing programs, or at another time. Automatically generated summaries can identify a desire or need based in part on the user's viewing habits that the viewer might not otherwise identify. For example, some summaries can be generated for demographic groups or other groupings of viewers. For example, a user's viewing history may suggest that a child is primarily viewing on the account, and summaries may be generated to include scenes understandable or age appropriate for a child, or may identify scenes that children typically enjoy. Similarly, summaries or flags may indicate that scenes are not appropriate for children and can initiate auto-skipping. The summaries can thus guide the user's viewing towards content that is compatible with current needs or interests.

Some examples of content summaries can be focused on particular individuals. For example, content summaries can be generated for specific characters of a program. For example, a character may be absent from a series for several episodes, and a viewer may want to review the character's past scenes of interest and not the entire series. In another example, summaries can be made to follow a particular sports player to identify highlights, plays of interest, or simply to follow the player whenever on screen.

Content summaries can be generated in any manner. In various embodiments, a locally-executing or remotely-available artificial intelligence (AI) agent can be prompted with a natural language query to generate relevant content summaries. The AI agent may be trained on metadata about media programs, if desired, including actual program content (e.g., timed text, audio and/or video content). The AI agent may obtain information about the identified program from public or private databases, crowdsourced data, social media, closed-loop viewing data, or other sources. Automatically-generated content summaries can be based on the viewing history of an individual viewer or of larger groups of viewers. By providing relevant and timely summaries, the automatically-generated content summaries can enhance the enjoyment of the viewing experience.

Various embodiments make use of large language models (LLMs) or similar generative AI constructs. The artificial intelligence capabilities may be executed by a server system associated with a content provider, by a viewer-associated device (e.g., a phone, tablet, or computer), or by a network service accessible to the content provider and/or the viewer device. In some implementations, the trained AI will receive a natural language query that is unique to the relevant program (e.g., “Identify the timestamp for the most-watched segment of program X”). The natural language queries may be further enhanced with viewer information (e.g., “Summarize the plot of program X for a teenager who reads at a 10th grade level without spoiling major plot points”), or with details about the program (e.g., “Identify scenes of interest in episode 5 of program X by timestamp for a viewer who has watched episodes 1 through 4 of program X”). Other embodiments may generate more sophisticated queries using any number of factors, as described more fully herein.

In some examples, the AI system can be trained on user data as well. AI systems trained on past user history and subsequent viewing habits and selections can assess scenes that are important to future scenes, important to sequels, important sporting moments, important to other episodes, frequently replayed, skipped, seek points, or other potential flag locations in content based on viewing habits. The AI system trained on viewing histories of users or demographic groups of users can also generate summaries and flag locations that tend to be more appealing to the current user when using the current user's demographics as an input. The AI system can compare the user's current traits or viewing activities to the user's past history to make summaries in some embodiments. The AI system can compare the user's current traits or viewing activities to histories of other groups of users that have had similar viewing traits and activities to identify future flag points and summaries relevant to groups of users. The AI system may generate summaries and flags aligning with those other groups of users and accounting for content already viewed by the user receiving the summaries and flags.

The AI techniques described herein may thus generate recaps of certain video content. The AI engine can assess which sections people watch more frequently by analyzing large quantities of content watching history. The AI engines of the present disclosure can also pull social media and timelines to determine which segments of video content are of particular interest to viewers, or of particular relevance for future content. Recaps of later episodes in a series that include a scene can be used to flag the original appearance of the scene in an earlier episode as important to the future episode. The AI engine can also consider closed captioning data or scripts for the content as a text-based input for evaluating the content. Using viewing history, user data, and content data, the AI engines described herein can identify the least important sections of a movie and flag, for example, when a viewer might visit the restroom or the kitchen. The AI engines of the present disclosure can also identify upcoming scenes of interest and flag the importance, for example, when something in the scene is relevant to future content. The AI systems can use the entirety of the content to show certain flags or indications to the viewing user about items that may be important in future portions of the content (e.g., context for later episodes, for later scenes, or for sequels).

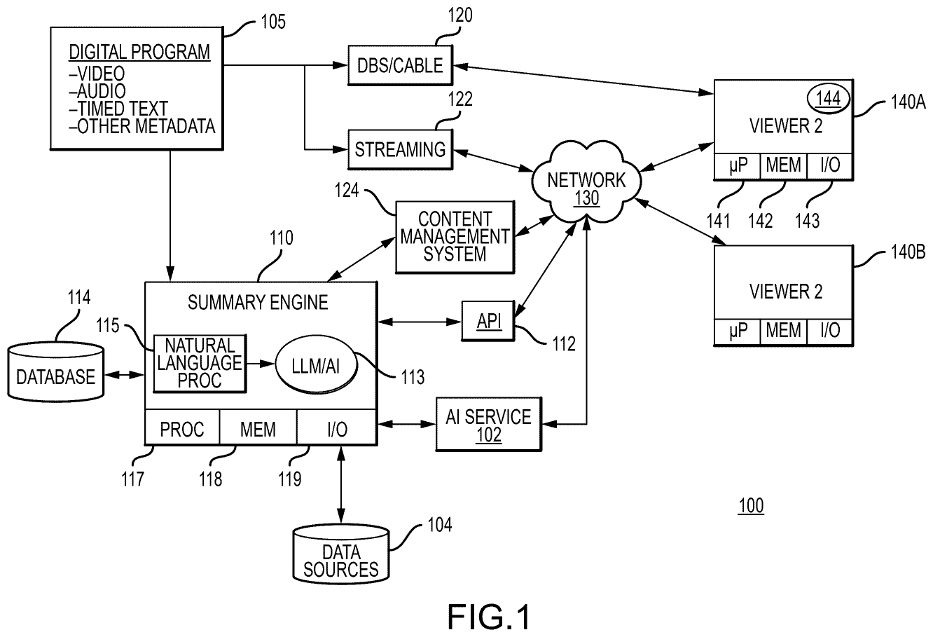

Turning now to the figures and with initial reference to FIG. 1, an example system 100 to automatically generate summaries for content is shown. System 100 may include a summary engine 110 that formats queries based upon information regarding a media program or a user to arrive at machine-generated summary. The queries can pass inputs as arguments into a function in embodiments using a compatible AI engine such as, for example, generative adversarial networks (GAN). LLM-based AI engines can accept text queries formatted as sentences. Any type of AI engine can be used and appropriate queries or inputs can be formulated by system 100 to pass as inputs metadata regarding a user and selected content. Automatically-generated summaries may be delivered to any number of media viewer devices 140A-B via a content management system (CMS) 124, via an application program interface (API) 112, or with the content itself as desired. The summaries can include flags for presentation along with the content during playback. In some embodiments, the flags can be searchable, seekable, selectable, or otherwise mark points for playback movement.

Summaries can be generated in any manner, based upon any available information about the particular media program stored, selected for viewing, or in playback. In various embodiments, a generative AI model 113 (or similar AI construct) executes within the summary generation engine 110 to process queries that result in automatically-generated summaries. Alternatively, summary engine 110 formats natural language queries or argument-based queries that can be posited to commercial LLMs, commercial databases, public databases, or other data sources 104 via the Internet or another network 130. Queries for AI model 113 and any resultant summaries or responses received from AI model 113 can be stored in a database 114 for subsequent retrieval or further processing, if desired. In some examples, summaries can be pre-processed and generated as generic summaries that can then be stored in association with the summarized content. Generic summaries stored with the summarized content can be retrieved nearly instantaneously in response to a user initiating playback of the content, as AI model 113 has already generated the generic summaries in some embodiments.

Digital content 105 may be received and delivered in any manner. Digital content 105 may also be referred to herein as a program, content, media, or other related terms. In various embodiments, digital content 105 is received via network 130, terrestrial broadcast, satellite broadcast, or in any other manner. Digital content 105 may include a multiplex of digital streams that are synchronized in time to represent a particular television program, movie, or other media program. An MPEG multiplex, for example, typically represents a media program with one or more video streams, one or more audio streams, one or more timed text streams, and associated metadata that encodes the content of the particular program 105. Generally speaking, the various component streams of the multiplex can be synchronized by common timing data, such as a presentation time stamp (PTS), so that content from the various video, audio, and timed text streams can be presented in synchrony to the viewer. Flags included in content summaries can also by synchronized with presentation of the video and audio, and can be visually positioned at an appropriate time on the navigation timeline during seek, scan, rewind, playback, or other viewing actions.

In some implementations, system 100 delivers digital content 105 to the various viewer devices 140A-B for playback. FIG. 1 illustrates a digital broadcast satellite (DBS) or cable connection 120 that provides a broadcast of the content, along with a video streaming system 122 that provides an over the top (OTT), IPTV, or other type of video stream. Although FIG. 1 illustrates both broadcast and streaming media delivery services, various embodiments of system 100 might include both, either, or some other distribution scheme. Other embodiments could deliver content 105 via any third-party or other broadcast or streaming services, as desired. Further, it is possible to deliver automatically-generated summaries separate from the content. The generated summaries can be delivered by system 100 that is separate from the delivery of the underlying content 105, in accordance with various embodiments.

Viewers can enjoy their media program content and receive automatically-generated summaries in any manner. In the example of FIG. 1, viewers make use of hardware devices 140A-B such as set-top boxes (STBs), smart televisions, video streaming devices, personal computers, mobile phones, tablets, or the like. Different viewers may make use of different types of devices 140A-B, each having computing hardware such as a processor 141, memory or other non-transitory digital storage 142, and suitable input-output interfaces 143, as desired. In the example of FIG. 1, the viewer controls his or her device 140A to select and view media programs 105, to receive summaries from system 100, to interact with flags, and to respond to system 100 via API 112 on network 130. Other embodiments could split the media viewing and summary-generation processes across two or more devices 140, if desired. A viewer may watch program 105 on a regular television set, for example, while simultaneously interacting with the automatically-generated summaries on a tablet, phone or personal computer.

Summary generation engine (SGE) 110 may operate in any manner. In the example of FIG. 1, SGE 110 and other computer-based systems described herein may execute firmware or software on conventional computing hardware such as one or more processors 117, memory or other non-transitory digital storage 118, and any appropriate input/output interfaces 119. Equivalent embodiments may make use of cloud-based computing resources such as the virtual machine architectures provided by Amazon Web Services (AWS), Microsoft Azure, Google Cloud, IBM Cloud, or the like.

SGE 110 processes available data and/or interacts with other services to generate the summaries referenced herein. In one example, SGE 110 supports an LLM, GAN, or other type of AI model 113 that is trained upon data relating to media programs 105, user viewing histories, use groupings, or other relevant data. The data may include actual program content, such as the audio content or the timed text content, as appropriate. Audio content may be analyzed after performing a speech-to-text conversion, as desired. In some embodiments, verbal audio can be analyzed using a script or using closed captioning data. Similarly, video content may be analyzed using a computer vision tool to analyze visual elements that can add understanding to the context (e.g., scene changes, key actions) if desired. Examples of such tools could include the Open Computer Vision Library (OpenCV), the TensorFlow tools available from Google Inc., or any number of other tools desired.

In many implementations, the timed text stream of program 105 will provide a detailed summary of the program contents, along with convenient timing information from the presentation time stamps or other timing data. The text may be analyzed to recognize characters, scenes, and other attributes of the media program. Flags can be generated for the timed text stream and assigned a presentation time and a flag type. Flag types can include popular, trending, rewatch, skip, important, relevant in future, low importance, or other types of flags enabling a user to better interact with or anticipate moments in the content. In addition or as an alternative to summaries derived from the program itself, AI model 113 may be additionally or alternately trained on additional metadata, or information about the program, that is available from data sources 104, such as any public database (e.g., Wikipedia), private database (e.g., the GRACENOTE media database service available from Gracenote, Inc. of Emeryville, California or the IMDB service maintained by Amazon Inc. of Seattle, Washington), user data, past interaction (e.g., rewind, skip, or pause) data, social media, traditional media, review sites, or the like.

In some implementations, metadata, program content, or any other data used to train the model may be provided to an AI framework that converts the received data to mathematical vectors that can be stored in a database for further processing and retrieval. Vectors may be stored in database 114, if desired, or in a separate database that is formatted for use by AI 113. After training, AI 113 may be configured to identify moments for flagging in content and generate a summary including the flags. AI 113 can analyze flags of interest for an individual user by comparing with the individual user's past viewing history to identify summaries likely to be well received by the individual user. AI 113 can analyze the flags of interest for an individual user by comparing with past viewing history of similar users to identify summaries likely to be well received by the individual user.

Network AI services 102 could also be used to obtain content, supplementary data, or otherwise assist in generating summaries. Examples of current AI services 102 may include the ChatGPT service available from OpenAI, the Bard service available from Google, the MetaAI service available from Meta Inc., or the Watson service available from IBM Corp. Additional AI services are being deployed rapidly, and any of these services could be equivalently used, if desired.

In some embodiments, SGE 110 deploys an LLM, GAN, or similar AI model 113 for automatically generating summaries based on digital content 105, the active user profile, similar user profiles, a viewing history, social media, traditional media, or other relevant data points. AI model 113 may be trained using a dataset that includes data such as the timed text (e.g., subtitles or captions) associated with digital content 105, as supplemented with data obtained from various data sources 104. Data sources 104 can include web-based sources, closed loop sources, private sources, social media sources, or third-party data sources. Additional data could include the title of the program, program genre, program characteristics, the names of actors and actresses appearing in the program, professional or amateur reviews or commentary, awards won by the program, and any other information useful in generating summaries. Additional data can also include playback interaction data and timestamps including rewind, seek, scan, playback, playback speed, pause, resume, skip, or other playback interaction data indicating what a user or a group of users has done when watching content. The inclusion of external web data can enhance the model's comprehension and contextual relevance, making it more effective in understanding and interacting with the content. Further, the use of additional data can be particularly helpful when there are gaps in the primary training dataset or when more diverse inputs are required to enhance the model's accuracy and effectiveness. As noted above, any received data can be provided to AI model 113 to generate sets of vectors that can be stored for use in subsequent analysis, including responses to natural language queries.

The architecture of AI model 113 can be designed to be flexible and to adapt to one or more existing frameworks if desired. These frameworks provide the foundational structure and learning algorithms for the LLM, GAN, or other AI model and may also provide resources for “training” custom models by converting input data to mathematical vectors or the like. Frameworks such as LLAMA from Meta Corporation, ChatGPT from OpenAI, and BARD from Google Inc. could be used, for example, to provide just a few examples of the many different frameworks that could be equivalently used. Custom-built AI frameworks could also be employed that are tailored to specific needs or objectives. Each of these frameworks has its unique strengths and methodologies, making them suitable for different aspects of language processing and learning.

In various embodiments, a natural language processing (NLP) module 115 allows for natural language queries to be placed to AI model 113 to generate summaries based upon relevant information. Some prompts may relate to general concepts (e.g., “List the timestamp and flag type for 10 scenes of interest in program X”). In some embodiments, however, summaries can be generated using prompts including additional reference to a particular viewer's attributes (e.g., prompts could be tailored based upon gender, geographic location, age, viewing history, genre preference, time constraints, or any number of other factors). Still further embodiments could generate different summaries based upon the viewer's playback point in the program, thereby offering summaries and flags after a long pause or after a viewer has stopped playback at a point where they would typically continue viewing. Again, prompts in an LLM-based example can be tailored as desired so that resulting summaries are specific to the program, as well as the viewer and the viewing position in the program.

AI model 113 and/or network AI service 102 process summary requests in any manner to produce the content summaries including flags. In various embodiments, the AI engine provides a framework for parsing the natural language query and for searching the vector space of generated vectors to arrive at suitable results. Other AI engines and implementations could operate in any other manner, using any sort of mathematical, statistical, data processing and/or other features to implement the AI model. Results can be digitally returned in response to the received queries via a network, via an inter-process or bus communication within data processing system SGE 110, or in any other manner. In some examples, SGE 110 can receive text-based summaries and generate links, thumbnails, previews, pages, auto-play triggers, or other interaction points at which the recommended program can begin playback. In some examples, the text-based summaries can identify scenes of particular relevance to groups of viewers, to general viewers, or to other segments of viewers. The scenes can be flagged as scenes of interest in some examples, and the scenes of interest can be compiled into a video recap.

Generated summaries and the like may be provided to the viewer devices 140A-B in any manner. In one example, media client applications 144 executed by viewer devices 140A-B communicate with the content management system 124 to provide digital updates about the viewing experience, including content requested, content viewed, viewing habits, viewing duration, and/or the like. Content management system 124 may also be involved with ad replacement or tracking, or other viewer experiences as desired. An example of a content management system that is used to track ad viewing within an adaptive media streaming environment is described in U.S. Pat. No. 11,463,785 (incorporated herein by reference), although other types of content management systems could be used in other embodiments. Such systems could be modified to distribute summaries and other data along with content.

In one example, content management system 124 obtains summaries based on the currently-viewed program and current user profile from SGE 110 and/or database 114. Received summaries are then forwarded to the viewer devices 140A-B. Summaries can be sent along with timed text data or viewing content in some embodiments. Alternatively, viewer devices 140A-B may communicate with SGE 110 or database 114 via API 112 to generate summaries locally. Summaries may be digitally presented to the viewer, and can be accepted or automatically triggered. In some embodiments, summaries can be retrieved, modified, or otherwise interacted with via API 112 for storage in database 114 or further processing.

The flags included in summaries can trigger skips, accelerated playback, slow playback, normal playback, rewinds, seeks, or other playback actions. In some embodiments, playback can automatically jump between flags, with the playback device automatically playing important scenes as flagged by the AI model. Playback can auto skip other flags that are not flagged as important in some embodiments. Flags including an action can have the associated action automatically triggered or triggered in response to user acceptance. Flags that include information for the user can be automatically presented during playback as an overlay. For example, a flag can be displayed in the corner of the screen to inform a reader an important scene is approaching or playing. In some embodiments, flags can be displayed on a playback timeline during seek, scan, or rewind functions to indicate to the viewer where they are in the content relative to the flag. The flags can be selectable to cause playback to skip to the flagged location or otherwise trigger an action associated with the flag.

In various embodiments, summaries can be presented in a visual interface that includes currently-playing content or selectable content along with summary data. The presentation can include viewer selectable flags to trigger playback actions associated with the flag. Various embodiments could alternately present the summaries, for example, as an overlay on the rendered video imagery. A presentation window could be presented in a window that is side-by-side with rendered imagery, for example. Still other embodiments could provide the automatically-generated summaries in a completely separate window, if desired. Even further, summaries could be presented on a separate device such as, for example, a smartphone or tablet. If a viewer is enjoying program content 105 on a television screen, for example, automatically-generated video recap or scene flag could be presented via a notification, text message, or companion application, and viewable on the viewer's smartphone, tablet, or other device. Timing could be coordinated between the two devices by sharing PTS or other playback timing data (e.g., via CMS 124) from the playback of the media program, thereby ensuring that summaries are not presented to the second device until the relevant playback point in program 105 has been reached (e.g., the scene of interest is approaching, an often skipped scene is approaching, a mature rated scene is approaching, etc.). Other embodiments may be formulated to permit convenient media playback and presentation of summaries.

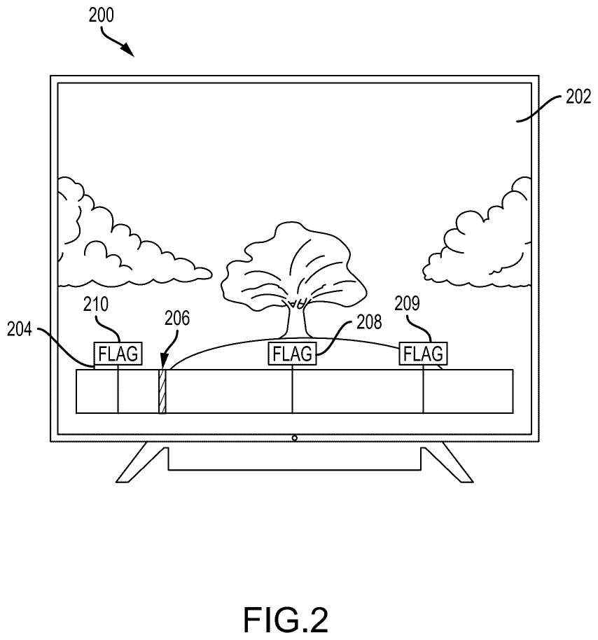

Referring now to FIG. 2, an example of an interface 200 is shown on display 202, in accordance with various embodiments. Interface 200 includes flags 208-210 overlayed and arranged in reference to a scrubber line 204. Current position indicator 206 indicates the current playback position of content in its playback timeline. In some embodiments, the flags may be overlaid on or around a seek bar, track slider, scrub bar, video timeline, or other visual representation of a time-based position in playback of the video, similar to interface 200 of FIG. 2. Flags displayed in this way can be selectable to trigger playback at the flagged time location.

In some examples, the flags can trigger other changes to playback settings such as, for example, volume change, pause, display brightness adjustment, display contrast adjustment, rewind, replay, skip, or other playback-related changes. For example, a parental control may be set indicating a young viewer is watching television. The resulting flags applied for the young viewer can automatically mute the audio during presentation of adult language or automatically black out the screen during playback of adult visual content. Settings can also effect the scenes collected in a video recap for a viewer.

The example of FIG. 2 illustrates the relationship of the AI-generated flags while the viewer is enjoying the selected program, and demonstrates the real-time (or near real-time) availability of flags to the viewer. Other embodiments could alternately present the flags in any other manner, or in less than real-time, if desired. Flags may be presented, e.g., as an overlay on the rendered video imagery instead of over the scrubber, if desired. The graphics of FIG. 2 may be arranged in other ways, if desired. The flags and scrubber may be generated in a window that is side-by-side with rendered imagery, for example, that scrolls as the content progresses. Still other embodiments could provide the automatically-generated flags and related scenes in a completely separate window, if desired. Even further, flags, flagged scenes, or video recaps may be presented on a separate device. If a viewer is enjoying program content 105 on a television screen, for example, automatically-generated flags and flagged scenes can be presented via a companion application executing on a smartphone, tablet, or other device at a time during content playback when the flagged scenes from earlier content are relevant. Timing may be coordinated between the two devices by sharing PTS or other playback timing data (e.g., via CMS 124) from the playback of the media program, thereby ensuring that flags and related scenes are presented to the second device at or near the relevant playback point in program 105. Other embodiments may be formulated to permit convenient media playback, flag presentation, recap presentation, or other information.

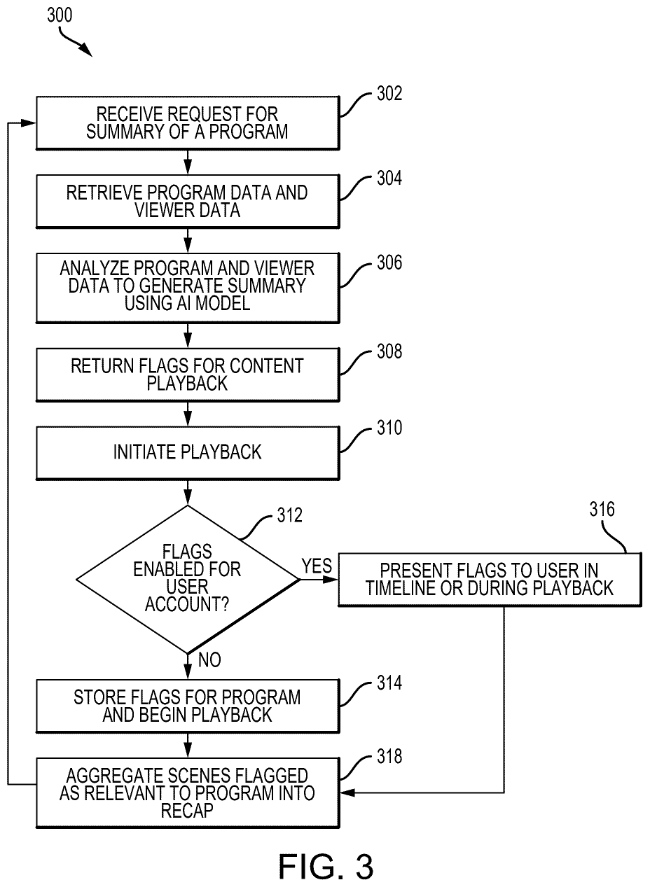

With reference to FIG. 3, an example process 300 is shown for automatic generation and delivery of summaries in media viewing system 100 of FIG. 1, in accordance with various embodiments. The various functions of process 300 may be performed using processor 117 executing software, firmware or other programmable logic, as augmented by the other components of system 100. Other embodiments may divide processing between the various components of system 100, including viewer devices 140A-B, as desired. In some implementations, a media application 144 could contain an AI model or other construct that has been trained on various user data and media programs so that some or all of the summary generation could be handled locally on devices 140A-B, thereby reducing processing demands on SGE 110. In this instance, media application 144 could interact with SGE 110 or another AI service 102 to supplement the local processing capability. In a further embodiment, an AI executing locally on viewer device 140A obtains initial summaries from SGE 110 or AI service 102 but generates supplementary summaries using a locally-executed model. To that end, summaries generated by AI elements executing on viewer device 140, SGE 110, and networked AI services 102 could be combined in any manner.

In various embodiments, automated process 300 may include receiving a request for a summary of a program (Block 302). The request can be triggered by any component of system 100 or other remote computing devices. In some embodiments, content management system 124 receives a request from user device 140A and formats a query for SGE 110. In some examples, SGE 110 can receive the request from content management system 124, from viewer device 140A-B, or from another computing device. AI service 102 can also receive the request in some examples. The request can be received in response to a media program being made available to a user, or in response to a user browsing into an information screen relating to a media program. In some examples, the request for a summary can be triggered in response to a user initiating playback of the media program. The summary can be triggered by a tile containing the media content being loaded into or queued for presentation to a user in a browsing interface. The summary can include flags for user presentation or interaction during playback. The summary can include a visual recap of the content for presentation to the user to summarize past important episodes, scenes, prequels, or other content that serves as context for the summarized content.

In response to the request for a summary, or in advance of the request in some embodiments, system 100 may retrieve data related to the program and viewer (Block 304). Program data can include metadata describing the program. Metadata describing the program or program data may include portions of the program itself (e.g., timed text), closed captioning data, program guide data, media relating to the program, playback data, feedback data from system 100, user interaction data, critical reception of the program, scripts, text summaries, social media tagging, or other information relating to the program, in addition to or as an alternative to other information about the media program that is available from other data sources 104. Viewer data can include viewer demographics, viewing history, viewer preferences, account settings, or other data relating to or describing the viewer.

In various embodiments, an AI model can analyze the program data and viewer data to generate a summary (Block 306). In some examples, the summary may be generated analyzing program data without viewer data. In one example, flags of a summary can be generated by considering playback data for all users to identify popular segments of the content and the most replayed segment of the content for presentation to the user. In yet another example, flags of a summary can be generated by considering playback data for users of a selected demographic group to identify popular segments of the content and the most replayed segment of the content by users in the selected demographic group for presentation to the user. In another example, flags can be generated based on relevance of scenes to future scenes in the same episode or movie, in future episodes, or in sequels. In a sports example, flags can be generated to identify scoring moments, penalties, celebrations, races, finishes, tournaments, highlights for a selected player, or other moments of interest in broadcasts or recordings of sporting events. AI model 113, AI service 102, or an AI model local to user device 140A can be variously used to analyze the program data and applicable user data.

System 100 can return the program summary including flags for content playback (Block 308). The program summary comprising flags can be returned to the requesting component of system 100 or other remote computing devices in communication with system 100. The summary can include a separate video recap in some examples, and the recap can comprise an aggregation of the flagged scenes of interest. The example of FIG. 3 includes a summary including both a complete video recap and flags for scenes as components of the summary, though the summary can include a stand-alone video recap without flags or stand-alone flags without a video recap, in various embodiments.

In some implementations, process 300 may be executed in real-time or near real-time, recognizing some delays inherent in data processing, digital communications, and the like. That is, automatically-generated summaries could be created in real time in response to a request from a trigger point in the current content, a request from the viewer, the viewer browsing a content selection interface, content management system 124 making new content available, broadcast of live content, recording of content beginning, or other triggers. This would permit highly customized summaries to be generated based upon the viewer's attributes, viewing history, and the like. Other embodiments could permit summaries to be generated prior to presentation, with the generated summaries being stored (e.g., in database 114) until an appropriate time for presentation to the viewer. Still other embodiments could combine these approaches by permitting some more generic summaries to be generated in advance, with additional summaries or refinements generated in response to the viewer's real time behavior or characteristics.

As noted above, program content 105 may be processed in any manner. In various embodiments, viewer device 140A identifies a program of interest via content management system 124. The program could be a recently added program, for example, or a program in a viewer's playlist, or the like. In some embodiments, certain programs 105 may be selected for analysis even before the particular viewer selects the program to improve response times. Continuing the LLM-based example, the LLM can be trained on metadata describing the program content, viewers, and their viewing habits, and default summaries can be generated for storage and subsequent use in association with the pre-processed program. In some embodiments, viewing histories can be stored and used for training and analysis.

AI 113 may be trained based upon dialog and scene changes of the program, for example, to learn about the program content and to determine timing information so that the various scenes in the program can be referenced with flags positioned precisely at or around scene changes. Other information about program 105 may be used to train AI 113 so that further context or detail can be learned. Other information could include any sort of information from public or private databases, as noted above, as well as any external AI services that may be available, as desired. Training the AI could involve any process or technique by which AI 113 becomes aware of the input data. As noted above, the AI may provide a framework or ingestion engine that receives input data that is then converted to mathematical vectors or the like for storage and subsequent processing. Data may be tagged, if desired, to permit more efficient recognition and conversion to digital format. Other embodiments may intake and analyze the received data in any other way.

In various embodiments, the summaries can be obtained from AI model 113 (or AI service 102) by placing a natural language query in the system using LLM or similar language-based AI models. SGE 110 or application 144 may include logic 115 for formatting natural language queries that can produce useful results from the trained AI 113. As noted above, queries may consider the viewer's demographic information, viewing history or preferences, past engagement with video recaps or flags, or the like in generating specific queries to the AI 113. Formatted queries can be provided to any trained AI model to receive automatically-generated results. Queries can be placed to AI 113 or the like that has been trained on the specific program 105, for example, to obtain customized results.

Various embodiments may posit queries to both a local AI model 113 and to a network AI service 102 to obtain additional information, for redundancy, or for any other purpose. Queries may be simultaneously submitted, if desired, or queries may be staggered so that one service provides different information (e.g., “filling in the gaps”) than the information received from the other service. Again, functions could be shared or intermixed between local and remote AI engines 113 and 102, respectively, in any manner. For example, it may not be necessary to train AI 113 on every program 105. Some commercially available AI services 102 may already be trained on certain media programs 105 (e.g., more popular movies), for example, so those services could be queried as appropriate for information that is within their knowledge base, without the need to duplicate that knowledge locally. Still further embodiments could obtain a “first draft” of summary materials from an external AI service 102, with a locally-executing AI 113 providing more detailed context, as well as an added layer of viewer anonymity, if desired. Other hybrid scenarios could be formulated to use local or remote AI resources in any manner.

In various embodiments, system 100 may initiate playback (Block 310). The flags included in the automatically generated summary may be presented to the user during playback in some examples. System 100 may check whether the user account associated with the viewer has flags enabled (Block 312). The flags may be enabled or disabled as an account setting or a parental control in some examples. Flags can be enabled or disabled by default. User account settings may be stored locally on user device 140A, by content management system 124, in database 114, or in other computing systems communicating with system 100 over a network. In some examples, flags may be permanently enabled for all users of system 100, or for groups of users on system 100.

System 100 may store flags in association with the program and begin playback (Block 314). Flags can be stored in database 114, on viewer device 140A, on content management system 124, or on other computing devices of or in communication with system 100. The flags may be presented to the viewer in a timeline or during playback (Block 316) in response to flags being enabled on the account. Flags may be presented using viewer device 140A or a supplemental computing device during playback of the content. The flags can be overlayed on the currently playing content as a button. For example, the summary can be selected and presented over the current content in response to a scene of interest approaching. The summary can be presented as a selectable button overlay that triggers playback at an associated flag location in response to the viewer pressing the button. The flag can be presented as an autoplay icon with a countdown until playback is triggered automatically. The flag can be presented as a tile or other entry on a browsing page, a tile in an interface, or an interface ribbon, for example.

Automatically-generated summaries can be provided to the viewer in any manner. If the summaries are generated locally on viewer device 140A-B, for example, summaries could be provided on a display via an interface as discussed above. If the summaries are generated by SGE 110, the results could be provided to the viewer's device 140A and/or to a companion device also associated with the viewer via content management system 124 or API 112. In one example, API 112 provides a secure hypertext transport protocol (HTTP) interface that interacts with client application 144 to request and receive automatically-generated summaries, although other embodiments could transfer the materials in other ways.

In various embodiments, AI 113 or AI service 102 can analyze past unused flags for the user in generating new summaries for the user. System 100 can thus avoid making the same types of unused flags or including the same type of scenes in video recaps for content that the viewer does not completely view, for example.

In various embodiments, system 100 can aggregate flagged scenes relevant to a selected program into a recap for the selected program (Block 318). Flags can be generated to identify segments, scenes, or moments from content that are relevant to later scenes during summary generation of block 306. The flagged scenes can be related to the later scenes to which they are relevant using a database, data store, or other linking techniques to store the association. In some examples, the flags can be stored in association with the particular content and can reference the flagged content, if different, in a manner suitable for retrieval or playback of the flagged scene. Flagged scenes relevant to a particular piece of content can be aggregated into an automatically generated recap for the particular piece of content.

For example, a viewer may be watching episode 3 of season 3 for a particular program. AI model 113 may have flagged one scene from episode 9 of season 1, two scenes from episode 3 of season 2, and one scene from episode 1 of season 3 as being relevant to the currently selected episode 3 of season 3 of the program. Content management system 124 (or any other computing device) can aggregate the flagged earlier content related to the currently selected episode 3 of season 3 of the program into an automatically-generated recap. The scenes can be reordered or arranged in a manner that makes sense to the viewer in the context of the recap, or in any other manner as desired. The recap can be delivered to the viewer through a primary or secondary viewing device. In some examples, the recap can be shown automatically before the selected program. In other examples, the recap of flagged content can be shown as the scene of the selected program (to which the flagged content is relevant) approaches. Other timing and delivery techniques can be used for recaps or flagged scenes.

Systems, methods, and devices of the present disclosure can truncate or abbreviate media consumption time by automatically flagging moments of interest. Viewers can navigate playback of content by interacting with flags overlaid on a timeline or on the content during playback. Flagged scenes can also be used to aggregate the moments of interest into a recap. Recaps tend to have abbreviated durations relative to the original content. Recaps can also include content from previous content flagged as relevant to the present content.

Benefits, other advantages, and solutions to problems have been described herein with regard to specific embodiments. Furthermore, the connecting lines shown in the various figures contained herein are intended to represent example functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. An automated process for generating flags and recaps for content, the automated process comprising:
retrieving program data related to a selected program in response to a request for a summary of the program;
analyzing the program data using an artificial intelligence (AI) model to generate flags for scenes of interest in the selected program; and
playing back the selected program with the flags overlayed on a timeline of the selected program during playback of the content.

2. The automated process of claim 1, wherein the flags identify the scenes of interest as containing content relevant to later content.

3. The automated process of claim 2, further comprising aggregating the scenes of interest identified by the flags to automatically generate a recap of the content relevant to the later content.

4. The automated process of claim 3, further comprising presenting the recap to a viewer in response to the viewer initiating playback of the later content.

5. The automated process of claim 1, wherein a flag from the flags identifies a playback action taken by other users at a corresponding location on the timeline of the selected program.

6. The automated process of claim 5, further comprising executing the playback action in response to a user interaction with the flag.

7. The automated process of claim 1, wherein the selected program comprises a sporting event, wherein the flag identifies a segment of the selected program including a scoring play.

8. The automated process of claim 1, wherein the selected program comprises a live event, wherein the request for a summary is generated in response to the live event ending.

9. The automated process of claim 1, wherein the selected program comprises a live event, wherein the request for a summary is generated in response to a recording of the live event completing.

10. The automated process of claim 1, wherein a flag from the flags identifies a segment of the selected content of low interest.

11. The automated process of claim 1, wherein a flag from the flags identifies a segment of the selected content in response to a person of interest to the viewer appearing in the segment.

12. The automated process of claim 1, further comprising:
presenting a first flagged scene of the selected content; and
skipping to a next flagged scene of the selected content in response to the first flagged scene ending.

13. An automated process for generating flags and recaps for content, the automated process comprising:
retrieving program data related to a selected program and viewer data related to a viewer in response to a request for a summary of the program;
analyzing the program data and the viewer using an artificial intelligence (AI) model to generate flags for scenes of interest to the viewer in the selected program;
aggregating the scenes of interest to the viewer into a recap, wherein the recap comprises a shorter duration than the selected program; and
playing back the recap to the viewer in response to the viewer initiating playback.

14. The automated process of claim 13, wherein the selected program comprises a sporting event, wherein the flags identify segments of the selected program containing highlights for a selected player.

15. The automated process of claim 13, wherein the flags identify the scenes of interest as containing content relevant to later content.

16. The automated process of claim 13, wherein a flag from the flags identifies a playback action taken by past viewers at a corresponding location on a timeline of the selected program.

17. The automated process of claim 16, further comprising executing the playback action in response to a user interaction with the flag.

18. The automated process of claim 13, wherein the selected program comprises a live event, wherein the request for a summary is generated in response to the live event being broadcast.

19. The automated process of claim 18, further comprising identifying additional flags in response to the live event progressing through the broadcast.

20. A non-tangible computer-readable medium configured to store instructions thereon that, when executed by a computer-based system, cause the computer-based system to perform operations, the operations comprising:
retrieving program data related to a selected program in response to a request for a summary of the program;
analyzing the program data using an artificial intelligence (AI) model to generate flags for scenes of interest in the selected program; and
playing back the selected program with the flags overlayed on a timeline of the selected program during playback of the content.
